(19) United States
(12) Patent Application Publication
(10) Pub. No.: US 2022/0366384 A1
(43) Pub. Date: Nov. 17, 2022

(54) TIP PAYMENT METHOD AND TERMINAL APPARATUS

(71) Applicant: GLORY LTD., Himeji-shi (JP)

(72) Inventors: Kenichi Tagashira, Hyogo (JP); Rikuo Minagawa, Hyogo (JP)

(21) Appl. No.: 17/319,126

(22) Filed: May 13, 2021

(51) Int. Cl. G06Q 20/08

(52) U.S. Cl. CPC G06Q 20/08

(57) ABSTRACT

Provided is a tip payment method performed by a system. The system includes a terminal apparatus and a server apparatus. The method includes: acquiring, by the terminal apparatus, information identifying the employee and a requested tip amount; receiving, by the terminal apparatus, a tip payment method; transmitting, by the terminal apparatus, the information identifying the employee and the requested tip amount to the server apparatus; performing, by the server apparatus, determination of whether tip payment of the requested tip amount is possible; receiving, by the terminal apparatus, a result of the determination from the server apparatus; and performing, by the terminal apparatus, processing of the tip payment of the requested tip amount according to the tip payment method preferred by the employee when the result of the determination indicates that the tip payment is possible.

### TECHNICAL FIELD

The present disclosure relates to a tip payment method and a terminal apparatus.

### BACKGROUND ART

Patent Literature 1 discloses a money handling apparatus that pays tips to tip recipients by cash.

### CITATION LIST

### Patent Literature

### PTL 1

WO 2014/132326

### SUMMARY

A tip payment method according to the present disclosure is performed by a system. The system includes: a terminal apparatus that is a computer comprising a man-machine interface; and a server apparatus that is a computer communicably connected to the terminal apparatus and stores a tip balance for each of employees. The tip payment method includes: acquiring, by the terminal apparatus, information identifying the employee; acquiring, by the terminal apparatus, a requested tip amount requested by the employee; receiving, by the terminal apparatus, a tip payment method preferred by the employee; transmitting, by the terminal apparatus, the information identifying the employee and the requested tip amount to the server apparatus; performing, by the server apparatus, determination of whether tip payment of the requested tip amount is possible based on the tip balance stored in association with the information identifying the employee and the requested tip amount; receiving, by the terminal apparatus, a result of the determination from the server apparatus; and performing, by the terminal apparatus, processing of the tip payment of the requested tip amount in accordance with the tip payment method preferred by the employee when the result of the determination indicates that the tip payment is possible.

### BRIEF DESCRIPTION OF DRAWINGS

FIG. 1 is a block diagram of a system;

FIG. 2 illustrates an exemplary screen of a man-machine interface of a terminal apparatus;

FIG. 3 illustrates exemplary data stored in the terminal apparatus;

FIG. 4 illustrates exemplary data stored in a server;

FIG. 5 is a sequence diagram describing a tip payment method performed by the system;

FIG. 6 illustrates another exemplary screen of the man-machine interface of the terminal apparatus;

FIG. 7 is a sequence diagram describing another tip payment method performed by the system;

FIG. 8 is a sequence diagram describing still another tip payment method performed by the system;

FIG. 9 is a sequence diagram describing still another tip payment method performed by the system;

FIG. 10 is a sequence diagram describing still another tip payment method performed by the system; and

FIG. 11 is a sequence diagram describing an exemplary report preparation.

### DESCRIPTION OF EMBODIMENTS

The conventional technique only allows paying tips to employees by cash. The present disclosure thus provides a technique of paying tips to employees by a payment method preferred by the employees.

An embodiment of the present disclosure will be described in detail below with reference to the accompanying drawings.

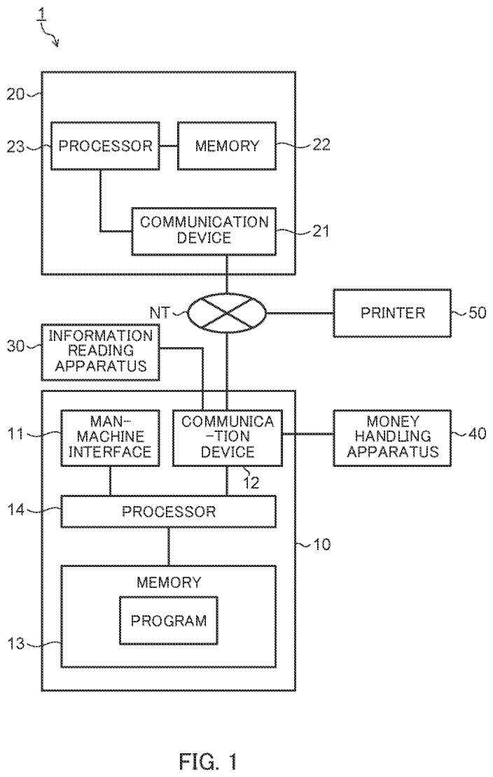

FIG. 1 is a block diagram of a system 1 according to the present disclosure. The system 1 comprises a terminal apparatus 10, a server 20, an information reading apparatus 30, a money handling apparatus 40, and a printer 50. The terminal apparatus 10 is communicably connected to the server 20 via a network NT. The information reading apparatus 30 is communicably connected to the terminal apparatus 10. The money handling apparatus 40 is communicably connected to the terminal apparatus 10. The printer 50 is communicably connected to the server 20 via the network NT.

The terminal apparatus 10 is a computer that comprises a man-machine interface 11, a communication device 12, a memory 13, and a processor 14. The terminal apparatus 10 is provided in facilities where employees can receive tips from customers, such as stores, restaurants, and hotels.

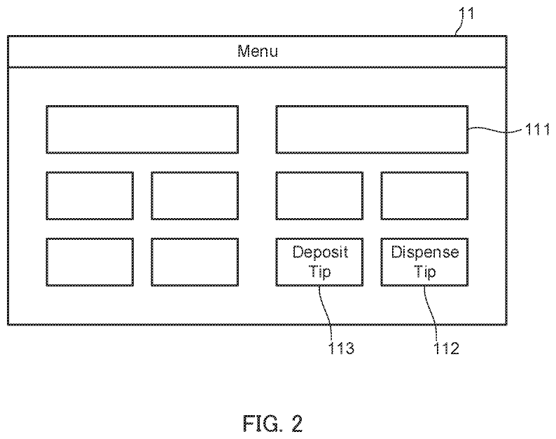

The man-machine interface 11 is a device or a group of devices that receives information inputs from operators of the terminal apparatus 10 and provides information to the operators. The man-machine interface 11 can comprise at least one of a display, a touchscreen display, a keypad, a pointing device, a card reader, a speaker, and a microphone, for example. In the present embodiment, the man-machine interface 11 comprises a touchscreen display. The man-machine interface 11 displays, for example, a screen illustrated in FIG. 2 when the terminal apparatus 10 is in standby mode. The screen illustrated in FIG. 2 comprises a plurality of buttons 111, 112, and 113. The button 111 is for giving instructions to the terminal apparatus 10 or another device connected to the terminal apparatus 10 (e.g., the money handling apparatus 40). The button 112 is touched for dispensing tips. The button 113 is touched for depositing tips.

The communication device 12 is a device or a group of devices for the terminal apparatus 10 to communicate with external computers or devices. The communication device 12 can comprise, for example, a network interface card or a semiconductor chip that controls a network interface. The communication device 12 may be configured to communicate with the external computers or devices either by wire or by radio.

The memory 13 stores programs for the terminal apparatus 10 to function. The memory 13 comprises, for example, a main memory such as a Static Random Access Memory (SRAM) and a Dynamic Random Access Memory (DRAM), and an auxiliary memory such as a Solid State Drive (SSD) and a Hard Disk Drive (HDD).

The memory 13 can store employees and tip payment methods available to the employees in association with each other. Exemplary tip payment methods are cash payment, transfer to a bank account, and transfer to a digital wallet account.

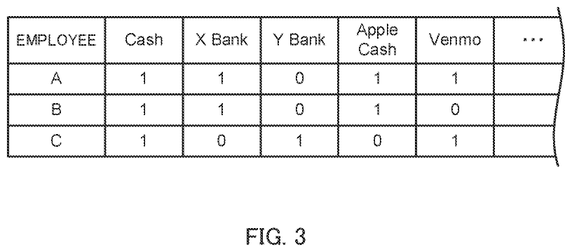

FIG. 3 illustrates an example of employees and tip payment methods available to the employees in association with each other. In the example in FIG. 3, an employee A is associated with “Cash”, “X bank”, “Apple Cash (registered trademark)”, and “Venmo (registered trademark)”, which are examples of the tip payment methods. That is, the employee A can select cash payment, transfer to an account in the X bank, transfer to an account in Apple Cash, which is a kind of digital wallets, or transfer to an account in Venmo, which is also a kind of digital wallets, as the tip payment method. Likewise, an employee B can select the cash payment, the transfer to an X bank account, or the transfer to an Apple Cash account as the tip payment method. An employee C can select the cash payment, transfer to an Y bank account, or the transfer to a Venmo account as the tip payment method. Note that information indicating which employees can choose which tip payment methods is registered in the terminal apparatus 10 in advance with account information such as account numbers provided by the employees.

The processor 14 comprises one or more arithmetic processors such as a Central Processing Unit (CPU) and a Micro-Processing Unit (MPU), and reads and executes programs stored in the memory 13. The processor 14 controls the whole terminal apparatus 10 including the man-machine interface 11, the communication device 12, and the memory 13, by executing the programs. Processing of the terminal apparatus 10 caused by the program execution of the processor 14 will be described later in detail.

The server 20 is a computer that comprises a communication device 21, a memory 22, and a processor 23. Note that the server 20 may be composed of a plurality of computers performing distributed processing, or may be a virtual computer virtually constructed by software. The server 20 may be provided in a facility where the terminal apparatus 10 is provided, or a place different from the facility. When the facility where the terminal apparatus 10 is provided is one of a plurality of branches, the server 20 may be provided in a head office of a business operator managing the plurality of branches.

The communication device 21 is a device or a group of devices for the server 20 to communicate with external computers or devices. The communication device 21 can comprise, for example, a network interface card or a semiconductor chip that controls a network interface.

The memory 22 stores programs for the server 20 to function. The memory 22 also stores various data on tips, which will be described later. The memory 22 comprises, for example, a main memory such as a SRAM and a DRAM, and an auxiliary memory such as an SSD and an HDD.

The memory 22 stores, for each employee, a received tip amount, a paid tip amount, and a tip balance in association with the employee. The memory 22 stores the received tip amount in association with the date and time when the tip is received and a tip receipt method. Exemplary tip receipt methods are receipt by cash, receipt by credit card payment, and receipt by debit card payment. The memory 22 also stores the paid tip amount in association with the date and time when the tip is paid. The paid tip amount may also be stored in association with the tip payment method. The tip balance is a value resulting from adding the received tip amount newly stored to the tip balance previously stored. Alternatively, the tip balance is a value resulting from subtracting the paid tip amount newly stored from the tip balance previously stored. Such data can be obtained from the terminal apparatus 10 or the money handling apparatus 40. Note that the memory 22 only needs to store at least the tip balance for each employee.

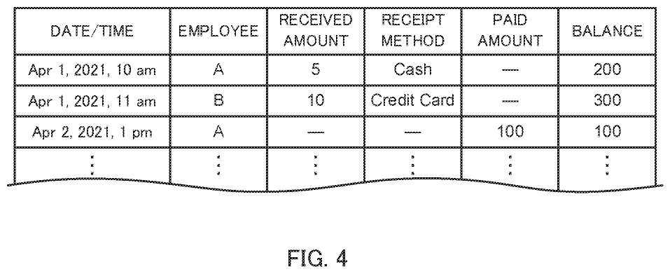

FIG. 4 illustrates exemplary data of the received tip amount, the paid tip amount, and the tip balance associated with identification information of the employees. The identification information of the employees is, for example, names of the employees, and employee numbers specific to the employees. FIG. 4 indicates that the employee A received 5 dollars in cash at 10 am on April 1 in 2021, and the tip balance for the employee A is updated to 200 dollars as a result. FIG. 4 also indicates that the employee B received 10 dollars by credit card payment at 11 am on April 1 in 2021, and the tip balance for the employee B is updated to 300 dollars as a result. FIG. 4 further indicates that the employee A withdrew the tips of 100 dollars at 1 pm on April 2 in 2021, and the tip balance for the employee A is updated to 100 dollars as a result.

Processor 23 comprises one or more arithmetic processors such as a CPU and an MPU, and reads and executes programs stored in the memory 22. The processor 23 controls the whole server 20 including the communication device 21, and the memory 22, by executing the programs. Processing of the server 20 caused by the program execution of the processor 23 will be described later in detail.

The information reading apparatus 30 reads information from a mobile information processor such as a smartphone. The information reading apparatus 30 can acquire information by reading the information from the mobile information processor through Near Field Communication (NFC), or reading a barcode or a pattern of a two-dimensional code displayed on the mobile information processor, for example. The information reading apparatus 30 is used for acquiring account information, which is information identifying the account of the employee, from the mobile information processor of the employee. The information reading apparatus 30 may be provided in a facility where the terminal apparatus 10 is provided, and may also be used for electronic payment for products or services by customers of the facility. Further, the information reading apparatus 30 may be a card reader that reads information from a credit card or a debit card. In this case, the information reading apparatus 30 is used for acquiring the account information from the credit card or the debit card of the employee. Additionally, the information reading apparatus 30 may also be used for credit card or debit card payment for products or services by customers.

The money handling apparatus 40 is capable of communicating with external computers and handling cash. The cash handling includes receiving cash deposits, storing cash, and dispensing the stored cash. The money handling apparatus 40 is configured to be capable of dispensing cash in accordance with instructions of the terminal apparatus 10. The money handling apparatus 40 is provided in a facility where the terminal apparatus 10 is provided. The money handling apparatus 40 may be operated by customers of the facility where the terminal apparatus 10 is provided, or by employees of the facility. The money handling apparatus 40 includes, a banknote/coin depositing and dispensing machine, an automated teller machine, a tax payment machine, a cash exchange machine, a ticketing machine, a vending machine, a change dispenser, a banknote recycler, and an electronic money charging machine.

The printer 50 receives data from external computers, and prints letters and patterns on paper. The printer 50 is provided in a facility where the terminal apparatus 10 is provided. The printer 50 may be provided in a facility where the server 20 is provided, or a facility different from the facility where the terminal apparatus 10 and the server 20 is provided.

The system 1 comprising the above-described configuration operates as follows.

### OPERATION EXAMPLE 1

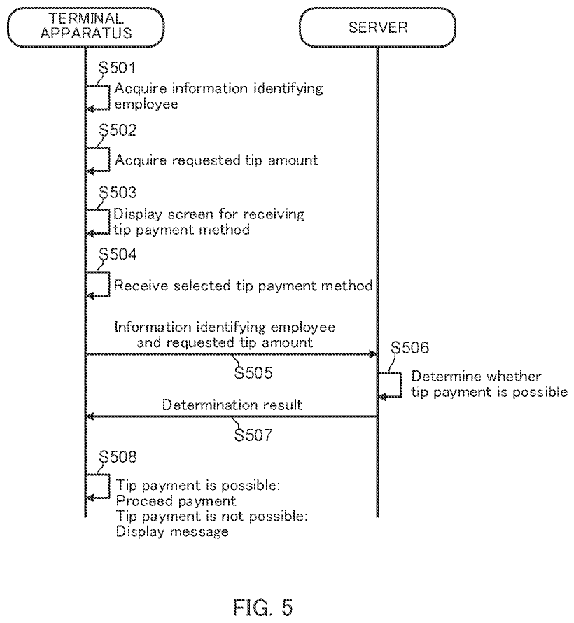

FIG. 5 is a sequence diagram describing an exemplary tip payment method performed by the system 1. It is sufficient for the system 1 to comprise at least the terminal apparatus 10 and the server 20 for this operation.

An employee asking for tip payment operates the terminal apparatus 10. For example, the employee touches the button 112 saying “Dispense Tip” on the screen of the man-machine interface 11 illustrated in FIG. 2. The employee then sees a screen to input information identifying the employee, such as an employee number, or the employee number and a password. The input of the information on the screen by the employee allows the terminal apparatus 10 to acquire the information identifying the employee (S501). When the man-machine interface 11 comprises a card reader, the card reader may read the information identifying the employee from an ID card of the employee to allow the terminal apparatus 10 to acquire the information. Note that the terminal apparatus 10 may identify the employee based on the information identifying the employee.

The terminal apparatus 10 displays a screen on which the employee inputs a tip amount to request (hereinafter, referred to as a “requested tip amount”) on man-machine interface 11. The requested tip amount is an amount of tips requested by the employee who asks for the tip payment. The input of the requested tip amount on the screen by the employee allows the terminal apparatus 10 to acquire the requested tip amount (S502). Note that the screen for the input of the information identifying the employee may also serve as the screen for the input of the requested tip amount.

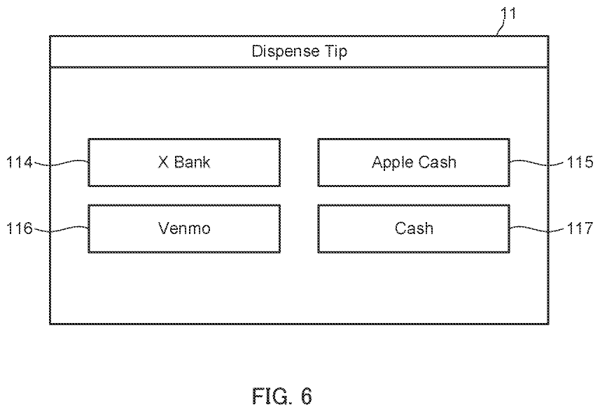

The terminal apparatus 10 then displays a screen for receiving a tip payment method preferred by the employee who asks for the tip payment on the man-machine interface 11 based on the information stored in the memory 13 (S503). When the employee A in FIG. 3 asks for the tip payment, the man-machine interface 11 can display the screen illustrated in FIG. 6. FIG. 6 illustrates a screen including four buttons for four options for the tip payment method. The button 114 is for instructing the transfer to the X bank account. The button 115 is for instructing the transfer to the Apple Cash account. The button 116 is for instructing the transfer to the Venmo account. The button 117 is for instructing the cash payment. The employee asking for the tip payment touches one of the four buttons, and the terminal apparatus 10 receives the tip payment method preferred by the employee accordingly (S504). Note that the tip payment method may be received by an input operation of a character string indicating a requested payment method without displaying the screen including a plurality of tip payment methods as illustrated in FIG. 6.

Subsequently, the terminal apparatus 10 transmits the information identifying the employee and the requested tip amount to the server 20 (S505). The information identifying the employee transmitted at this time may be the information identifying the employee received by the terminal apparatus 10 (e.g., the information specific to the employee) as it is, or may be information generated by the terminal apparatus 10 or extracted from the memory 13 based on the received information. The information identifying the employee is information to be used by the server 20 to identify the employee (e.g., the name of the employee). When the information received by the terminal apparatus 10 is transmitted to the server 20 as it is, as the information identifying the employee, the terminal apparatus 10 need not identify the employee in S501.

The server 20 identify the employee asking for the tip payment based on the information identifying the employee received from the terminal apparatus 10. The server 20 determines whether the tip payment of the requested tip amount is possible based on the tip balance stored in association with the identified employee and the requested tip amount (S506). The tip payment is determined to be possible when the requested tip amount is equal to or less then the tip balance. In a case where the employee B in FIG. 4 asks for the tip payment, and the server 20 has received information identifying the employee B and the requested tip amount from the terminal apparatus 10 after 11 am on April 1 in 2021, the tip payment of 300 dollars or less is possible since the tip balance is 300 dollars. Thus, the server 20 determines that the payment is possible when the requested tip amount is 300 dollars or less, or determines that the payment is not possible when the requested tip amount is more than 300 dollars.

Note that a transfer fee is required depending on the selected account when the transfer to the account is selected as the tip payment method. In this case, the payment is determined to be possible when the sum of the requested tip amount and the transfer fee is equal to or less than the tip balance.

The server 20 transmits the determination result to the terminal apparatus 10, and the terminal apparatus 10 receives the determination result (S507).

When the received determination result indicates that the payment is possible, the terminal apparatus 10 performs tip payment processing according to the tip payment method preferred by the employee who asks for the tip payment (S508). When the tip payment method preferred by the employee who asks for the tip payment is the transfer to the account, the terminal apparatus 10 performs processing of transferring to the account. The terminal apparatus 10 may display the amount to be transferred on the man-machine interface 11. When the account requested by the employee requires the transfer fee, the terminal apparatus 10 may display the transfer fee on the man-machine interface 11 as well as displaying the amount to be transferred resulting from subtracting the transfer fee from the requested tip amount.

When the received determination result indicates that the payment is not possible, in contrast, the terminal apparatus 10 displays a message indicating that the payment is not possible (S508). At this time, the requested tip amount may be inputted again by the employee while displaying the tip balance.

Note that an application for the tip payment processing is automatically selected so as to be suitable for the tip payment method, i.e., the kind of the account to which the tip is transferred. When the account to which the tip is transferred is a bank account, transfer information is transmitted to a server of the bank. When the account to which the tip is transferred is a digital wallet account, transfer information is transmitted to a server of a business operator providing the digital wallet service.

### OPERATION EXAMPLE 2

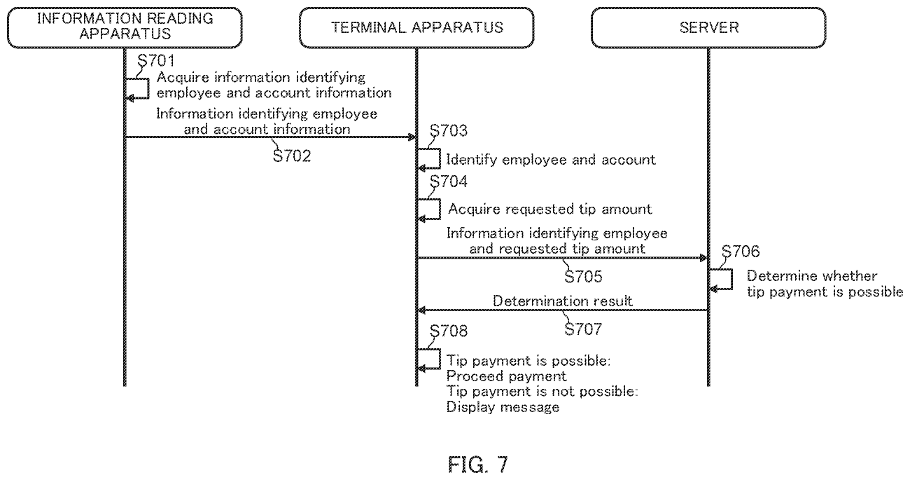

FIG. 7 is a sequence diagram describing another exemplary tip payment method performed by the system 1. It is sufficient for the system 1 to comprise at least the terminal apparatus 10, the server 20, and the information reading apparatus 30 for this operation.

An employee asking for tip payment brings a mobile information processor such as a smartphone of his/her own close to the information reading apparatus 30. The mobile information processor is prepared in advance to provide information on an account to which the employee requests a tip transfer. In other words, the information is ready to be read on the mobile information processor. For example, a barcode or a pattern of a two-dimensional code used for identifying the account has been displayed on the screen of the mobile information processor. Alternatively, selection of an application to be launched for NFC has been completed on the mobile information processor. The application to be launched is an application capable of externally providing, by NFC, the information on the account to which the tips are transferred, including an application for using a service of a digital wallet, such as Apple Cash or Venmo, or a service of a bank, for example. The information reading apparatus 30 acquires information identifying the employee and the account information from the mobile information processor without contact (S701).

The information reading apparatus 30 transmits the information identifying the employee and the account information to the terminal apparatus 10, and the terminal apparatus 10 receives the information (S702). The employee brings the mobile information processor close to the information reading apparatus 30 so that the information reading apparatus 30 can acquire the account information because the employee requests a tip transfer to an account to be identified from the account information. That is, the transfer to the account to be identified from the account information is the tip payment method preferred by the employee. Thus, the receipt of the account information by the terminal apparatus 10 corresponds to the receipt of the tip payment method preferred by the employee by the terminal apparatus 10.

The terminal apparatus 10 then identifies the employee asking for the tip payment and the account of the employee (S703), and acquires a requested tip amount (S704). The terminal apparatus 10 acquires the requested tip amount in the same manner as in S502 described in FIG. 5.

The subsequent steps from S705 to S708 are performed as in steps from S505 to S508 described in FIG. 5.

According to Operation Example 2, a simple operation by an employee enables transferring tips to an account requested by the employee, and the employees can receive the tips in the account.

### OPERATION EXAMPLE 3

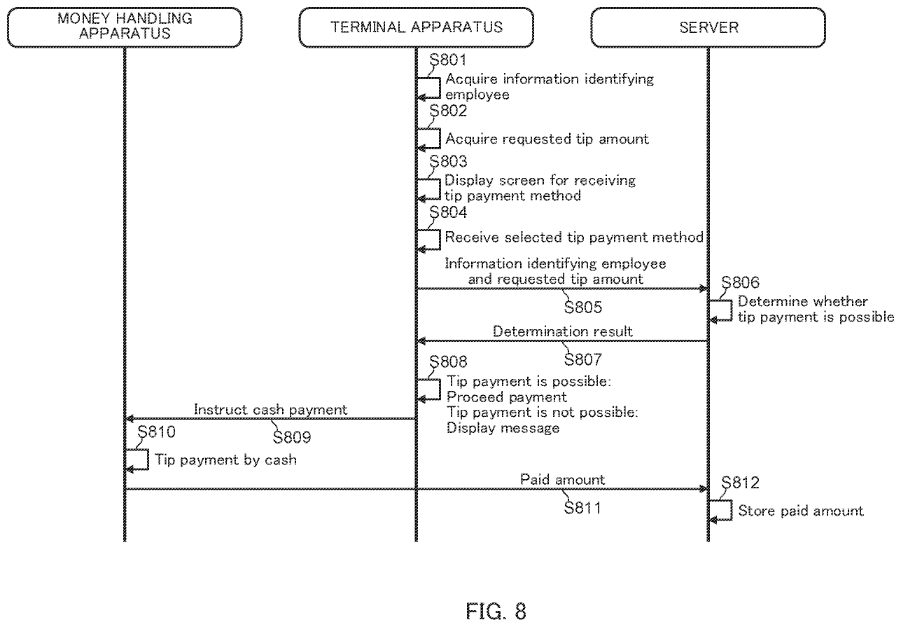

FIG. 8 is a sequence diagram describing still another exemplary tip payment method performed by the system 1. It is sufficient for the system 1 to comprise at least the terminal apparatus 10, the server 20, and the money handling apparatus 40 for this operation.

In the present operation example, steps from S801, which is acquisition of information by the terminal apparatus 10 from an employee asking for tip payment, to S808, which is tip payment according to a determination result received from the server 20, are performed in the same manner as in the corresponding steps in FIG. 5, i.e., the steps from S501 to S508.

When a tip payment method preferred by the employee is cash payment, and the determination result received from the server 20 indicates that the payment is possible, the terminal apparatus 10 instructs the money handling apparatus 40 to dispense a requested tip amount in cash (S809).

The money handling apparatus 40 receives the instruction and dispenses the requested tip amount in cash (S810). This allows the employee asking for the tip payment by cash to receive the requested tip amount in cash as requested.

The money handling apparatus 40 then transmits the paid amount, which is an amount of tips dispensed in cash, to the terminal apparatus 10, and the terminal apparatus 10 transmits the received paid amount to the server 20 (S811). Note that the money handling apparatus 40 may transmit the paid amount to the server 20 directly via the network NT.

The server 20 stores the received paid amount in association with the employee (S812). In a case where the employee A in FIG. 4 received a tip payment in cash from the money handling apparatus 40 at 1 pm on April 2 in 2021, and the paid amount is 100 dollars, the server 20 stores various data in association with each other as represented in the third row of the chart in FIG. 4. To be more specific, the server 20 stores “Apr. 2, 2021, 1 pm” as the date and time, “A” as the employee, “100” as the paid amount, and “100” as the balance in association with each other. At this time, “cash” may also be stored as the payment method in association with such information.

Note that the money handling apparatus 40 may operate as follows when the money handling apparatus 40 is an apparatus possibly dispensing cash as change in processing payments made by customers, such as a change dispenser. When receiving the instruction of dispensing tips from the terminal apparatus 10, the money handling apparatus 40 may confirm whether an inventory amount is equal to or more than a predetermined amount, and dispense the tips when the inventory amount is equal to or more than the predetermined amount. This operation prevents a shortage of cash for change in advance. In the case where the money handling apparatus 40 operates as described above, the money handling apparatus 40 may transmit information indicating a failure of the tip payment by cash due to the shortage of cash to the terminal apparatus 10, and the terminal apparatus 10 may display a message indicating the information on the man-machine interface 11.

### OPERATION EXAMPLE 4

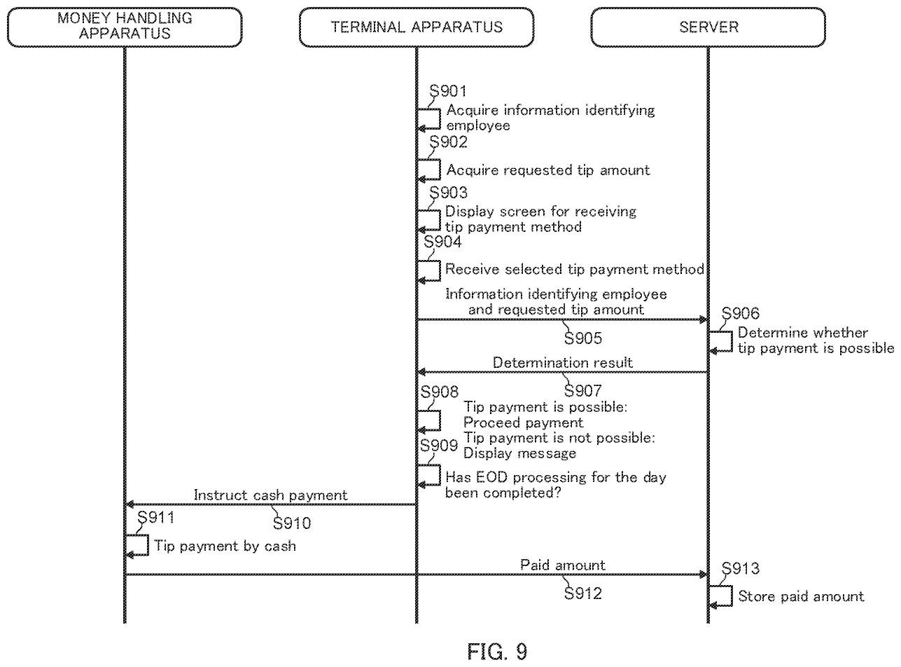

FIG. 9 is a sequence diagram describing still another exemplary tip payment method performed by the system 1. It is sufficient for the system 1 to comprise at least the terminal apparatus 10, the server 20, and the money handling apparatus 40 for this operation. This operation is performed in a case where the money handling apparatus 40 is an apparatus possibly dispensing cash as change in processing payments made by customers, such as a change dispenser.

In the present operation example, steps from S901, which is acquisition of information by the terminal apparatus 10 from an employee asking for tip payment, to S908, which is tip payment according to a determination result received from the server 20, are performed in the same manner as in the corresponding steps in FIG. 8, i.e., the steps from S801 to S808.

When a tip payment method preferred by the employee is cash payment, and the determination result received from the server 20 indicates that the payment is possible, the terminal apparatus 10 further determines whether End-of-Day (EOD) processing for the day has been completed (S909). The EOD processing is so-called closing processing, and performed for calculating and finalizing sales for the day. No change is dispensed from the money handling apparatus 40 after the EOD processing. That is, the tip payment by cash does not cause a shortage of cash for change. Thus, the present operation example sets completion of the EOD processing as a condition of the tip payment by cash from the money handling apparatus 40. Note that the determination whether the EOD processing for the day has been completed (S909) may be performed at any stage after receiving the cash payment at S904 where the tip payment method is received.

When the EOD processing for the day has been completed, the terminal apparatus 10 instructs the money handling apparatus 40 to dispense a requested tip amount in cash (S910).

The subsequent steps from the tip payment by cash to the storage of the paid amount, i,e., from S911 to S913, are performed in the same manner as in the corresponding steps in FIG. 8, i.e., the steps from S810 to S812.

As described above, Operation Example 4 prevents a shortage of cash for change in the money handling apparatus 40 in advance.

### OPERATION EXAMPLE 5

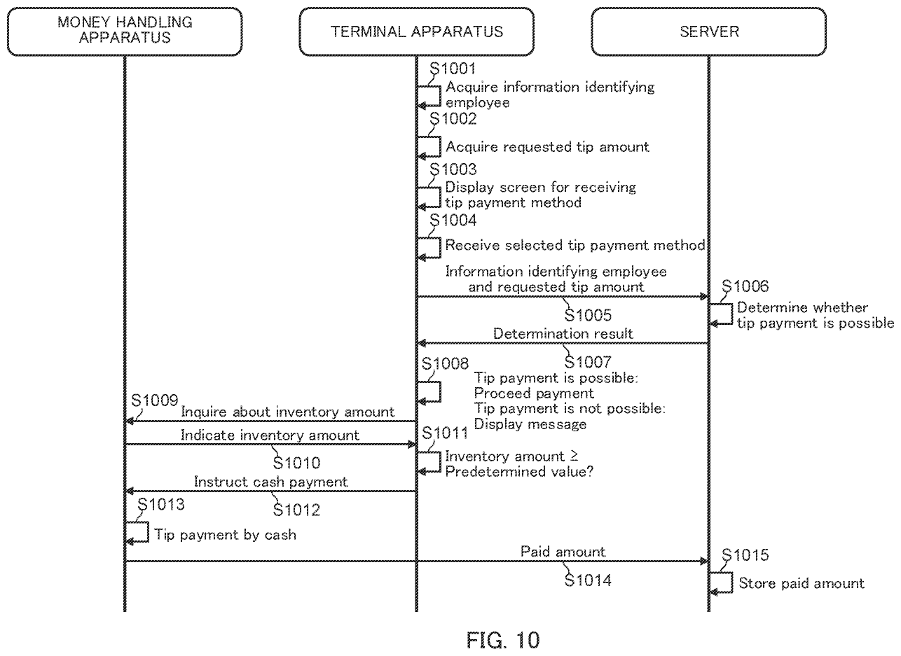

FIG. 10 is a sequence diagram describing still another exemplary tip payment method performed by the system 1. It is sufficient for the system 1 to comprise at least the terminal apparatus 10, the server 20, and the money handling apparatus 40 for this operation. This operation is performed in a case where the money handling apparatus 40 is an apparatus possibly dispensing cash as change in processing payments made by customers, such as a change dispenser.

In the present operation example, steps from S1001, which is acquisition of information by the terminal apparatus 10 from an employee asking for tip payment, to S1008, which is tip payment according to a determination result received from the server 20, are performed in the same manner as in the corresponding steps in FIG. 8, i.e., the steps from S801 to S808.

When a tip payment method preferred by the employee is cash payment, and the determination result received from the server 20 indicates that the payment is possible, the terminal apparatus 10 inquires of the money handling apparatus 40 about an inventory amount of the money handling apparatus 40 (S1009). The money handling apparatus 40 indicates the inventory amount to the terminal apparatus 10 (S1010). The terminal apparatus 10 determines whether the inventory amount is equal to or greater than a predetermined amount (S1011). When the inventory amount is equal to or greater than the predetermined amount, the tip payment by cash is unlikely to cause a shortage of cash for change. Thus, the present operation example sets the predetermined amount or more of the inventory amount as a condition of the tip payment by cash from the money handling apparatus 40. Note that the steps from S1009 to S1011, which are for confirmation of the inventory amount of the money handling apparatus 40, may be performed at any stage after receiving the cash payment at S1004 where the tip payment method is received.

When the inventory amount of the money handling apparatus 40 is equal to or greater than the predetermined amount, the terminal apparatus 10 instructs the money handling apparatus 40 to dispense a requested tip amount in cash (S1012).

The subsequent steps from the tip payment by cash to the storage of the paid amount, i,e., from S1013 to S1015, are performed in the same manner as in the corresponding steps in FIG. 8, i.e., the steps from S810 to S812.

As described above, Operation Example 5 prevents a shortage of cash for change in the money handling apparatus 40 in advance.

### OPERATION EXAMPLE 6

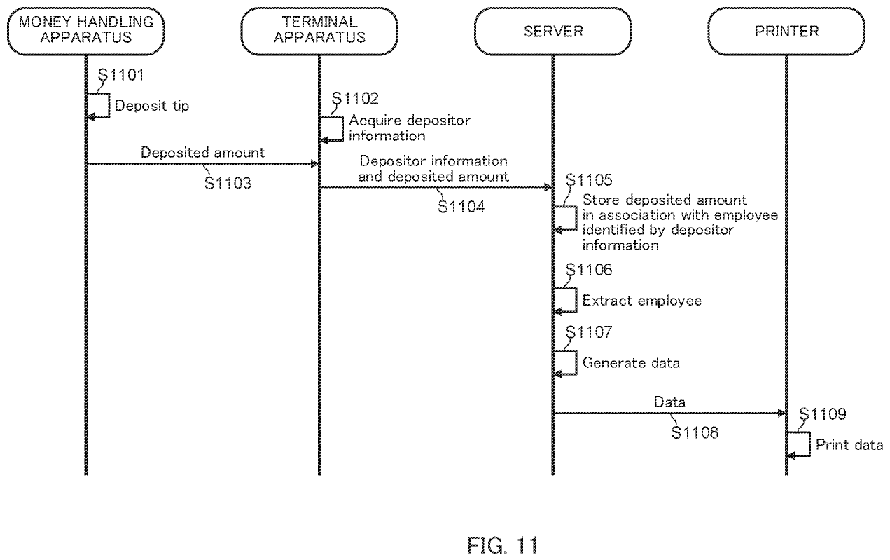

FIG. 11 is a sequence diagram describing an exemplary report preparation performed by the system 1. It is sufficient for the system 1 to comprise at least the terminal apparatus 10, the server 20, the money handling apparatus 40, and the printer 50 for this operation.

An employee who has received a tip from a customer in cash deposits the cash received as the tip in the money handling apparatus 40 (S1101). Before or after the deposit, the employee operates the man-machine interface 11 of the terminal apparatus 10, and inputs depositor information identifying that the depositor of the cash is the employee who has received the cash as the tip. The depositor information is information identifying the employee such as an employee number and a password. This operation allows the terminal apparatus 10 to acquire the depositor information (S1102).

The money handling apparatus 40 transmits an amount of the deposited cash to the terminal apparatus 10, and the terminal apparatus 10 receives the deposited amount (S1103). The terminal apparatus 10 transmits the depositor information and the deposited amount to the server 20, and the server 20 receives the information and the amount (S1104).

The server 20 identifies the employee who has deposited the cash in the money handling apparatus 40 using the received depositor information, and stores the received deposited amount in association with the identified employee (S1105). In a case where the employee A in FIG. 4 deposited cash received as a tip at 10 am on April 1 in 2021, the deposited amount is 5 dollars, and a tip balance for the employee A before the deposit was 195 dollars, the tip balance for the employee A is updated to 200 dollars, resulting from adding the deposited 5 dollars to the original tip balance of 195 dollars. In this case, the server 20 stores, as illustrated in the first row of the chart in FIG. 4, “Apr. 1, 2021, 10 am” as the date and time, “A” as the employee, “5” as the received amount, “cash” as the receipt method, and “200” as the balance in association with each other.

Although not described in FIG. 11, in a case where an employee receives a tip in a receipt method other than cash, the server 20 also receives the depositor information and the deposited amount from the terminal apparatus 10, and stores the deposited amount in association with the employee identified by the depositor information. At this time, information indicating the tip receipt method other than cash (e.g., credit card payment or debit card payment) is also transmitted to the server 20 from the terminal apparatus 10. In a case where the employee B in FIG. 4 received 10 dollars as a tip by the credit card payment at 11 am on April 1 in 2021, and a tip balance for the employee B before receiving the tip of 10 dollars was 290 dollars, the tip balance for the employee B is updated to 300 dollars, resulting from adding the received 10 dollars to the original tip balance of 290 dollars. In this case, the server 20 stores, as illustrated in the second row of the chart in FIG. 4, “Apr. 1, 2021, 11 am” as the date and time, “B” as the employee, “10” as the received amount, “credit card” as the receipt method, and “300” as the balance in association with each other.

Such data related to the deposit is stored and accumulated each time the tip is received regardless of the tip receipt method.

The server 20 extracts, from the information stored in the memory 22, employees who have received tips of a predetermined amount (e.g., 20 dollars) or more in total during a predetermined period (e.g., in a month) when receiving a report preparation instruction, or the server 20 automatically performs the extraction at a predetermined date and time, such as the close of business at the end of each month (S1106).

The server 20 then generates data for preparing the report on the tip amount received by such an extracted employee in the predetermined period based on the tip received amount stored in association with the employee (S1107). The data may include (a) a total amount of tips received in cash in the predetermined period, (b) a total amount of tips received by credit card payment and tips received by debit card payment in the predetermined period, and (c) a total amount of the tips received in cash, the tips received by credit card payment, and the tips received by debit card payment in the predetermined period. Specific information to be included in the data for preparing the report on the tip receipt amount can be set as appropriate by a user of the system 1.

The server 20 transmits the generated data to the printer 50 (S1108). The printer 50 receives the data, and prints the data in a predetermined format (S1109).

As described above, Operation Example 6 allows a user of the system 1 to easily prepare a report on tips received by an employee in a predetermined period.

Note that the system 1 can perform above-described operation examples in combination. In the operation examples described in FIGS. 8 and 9, for example, the terminal apparatus 10 may acquire the information identifying the employee and the account information via the information reading apparatus 30, as in the operation example described in FIG. 7.

1. A method of paying a tip to an employee that requests payment of the tip and is identified by identification information, the method performed by a terminal apparatus operated by the employee, a server that is communicably connected to the terminal apparatus and stores a tip balance for the employee, and a money handling apparatus communicably connected to the terminal apparatus, the method comprising:
acquiring, by the terminal apparatus, the identification information that the employee inputs to the terminal apparatus;
acquiring, by the terminal apparatus, a tip amount, as a requested tip amount, that the employee requests and inputs to the terminal apparatus;
receiving, by the terminal apparatus, a tip payment method that is selected by the employee from a plurality of methods including a first method of the payment of the tip by cash, a second method of the payment of the tip by transfer to a bank account and a third method of the payment of the tip by transfer to a digital wallet account and inputs to the terminal apparatus;
transmitting, by the terminal apparatus, the identification information and the requested tip amount that are acquired by the terminal apparatus to the server;
identifying, by the server, the employee that requests the payment of the tip;
determining, by the server, whether the requested tip amount is a possible amount to pay the tip to the identified employee or not based on the tip balance stored, in the server, in association with the identification information and the requested tip amount that are received from the terminal apparatus by the server;
receiving, by the terminal apparatus, a result of the determination by the server from the server;
performing, by the terminal apparatus, processing of the payment of the requested tip amount of the tip in accordance with the tip payment method selected by the employee when the server determines that the requested tip amount is the possible amount to pay the tip to the identified employee;
instructing, by the terminal apparatus, the money handling apparatus to dispense cash for the requested tip amount when the tip payment method selected by the employee is the first method and the server determines that the requested tip amount is the possible amount to pay the tip to the identified employee; and
dispensing, by the money handling apparatus, the cash for the requested tip amount when the money handling apparatus receives an instruction to dispense cash from the terminal apparatus.

2. The method according to claim 1, further comprising:
displaying, by the terminal apparatus, the plurality of methods including the first method, the second method and the third method on a screen of the terminal apparatus; and
receiving, by the terminal apparatus, the tip payment method selected by the employee through an operation of selecting one of the plurality of tip payment methods, the operation performed by the employee on the screen.

3. The method according to claim 1, further comprising:
selecting, by the terminal apparatus, an application for performing the processing of the payment of the tip based on the tip payment method selected by the employee.

4. The method according to claim 1, further comprising:
acquiring, by an information reading apparatus communicably connected to the terminal apparatus, account information for identifying an account of the employee;
receiving, by the terminal apparatus, the account information from the information reading apparatus; and
identifying, by the terminal apparatus, the account based on the account information.

5. The method according to claim 1, further comprising:
receiving, by the server, from either the terminal apparatus or the money handling apparatus, a paid amount that is an amount of the cash dispensed from the money handling apparatus; and
storing, by the server, the paid amount in association with the employee.

6. The method according to claim 5, further comprising:
instructing, by the terminal apparatus, the money handling apparatus to dispense cash for the requested tip amount when the tip payment method selected by the employee is the first method, the server determines that the requested tip amount is possible to pay the tip to the identified employee, and the terminal apparatus has completed End Of Day (EOD) processing.

7. The method according to claim 5, further comprising:
storing, by the server apparatus, a difference between the tip balance stored in the server in association with the employee and the paid amount as a new tip balance in association with the employee.

8. The method according to claim 1, further comprising extracting, by the server, the employee whose received tip amount in a predetermined period is a predetermined amount or more in total, and generating, by the server, data for preparing a report on the received tip amount in the predetermined period for the extracted employee based on the received tip amount stored in the server in association with the extracted employee.

9. The method according to claim 8, the method further comprising:
acquiring, by the terminal apparatus, depositor information identifying the employee who deposits cash in a money handling apparatus communicably connected to the terminal apparatus;
transmitting, by the money handling apparatus, to the terminal apparatus, a deposited amount that is an amount of the cash deposited in the money handling apparatus;
transmitting, by the terminal apparatus, the depositor information and the deposited amount to the server; and
storing, by the server, the deposited amount as the received tip amount in association with the employee identified by the depositor information.

10. The method according to claim 8, wherein the data includes (a) a total amount of tips received by cash in the predetermined period, (b) a total amount of tips received by credit card payment and tips received by debit card payment in the predetermined period, and (c) a total amount of the tips received in cash, the tips received by credit card payment, and the tips received by debit card payment in the predetermined period.

11. The method according to claim 8, the method further comprising:
receiving the data by a printer communicably connected to at least either the terminal apparatus or the server apparatus; and
printing the data in a predetermined format by the printer.

12-15. (canceled)
